(19) United States
(12) Patent Application Publication
(10) Pub. No.: US 2003/0004704 A1
(43) Pub. Date: Jan. 2, 2003

(54) System and method of spreadsheet-based string localization

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 09/897,347

(22) Filed: Jul. 2, 2001

(51) Int. Cl. G06F 17/20

(52) U.S. Cl. 704/8

(57) ABSTRACT

The present invention is directed to a system of and method for creating localization data which is used to update instruction manuals, books, and user interfacing portions of computer programs to contain words, phrases, sentences, and paragraphs in local languages when the product is purchased by an individual who desires to look at the information in a language other than the language in which it was created. The invention also includes a system for and a method of tracking and highlighting changes in the localization data to ensure the word or words in the foreign languages remain synchronized with the word or words in the base or original language.

### BACKGROUND

Typically, when a manufacturer sells a product, written instructions or instruction manuals are included with the product when sold. Similarly, when a software manufacturer sells software, the software typically includes strings forming words, phrases, sentences and paragraphs including information concerning the operation of the product for use by the end user. When a manufacturer sells products in its home country, a single version of instructions or messages is used to convey, or receive information to/from the user (interfacing message(s)). However, when a product is marketed to a country whose citizens speak several languages, or is shipped to different countries whose national language is different than the base language used to compose the instructions or user information, the base language interfacing messages must be translated to other, i.e. foreign, languages. For example, many foreign countries have laws which dictate that particular portions of instruction manuals or user interface portions of programs must be presented in the native or official language of the country.

Typically, software programs are written in some base language which is typically the native language of the country in which the program is created. In the United States, this base language would be English. While the majority of the software program is not translated when the program is sold in a foreign country (e.g., the portion representing executable code and variables), portions of the program which are used to convey information to the end user, or receive input from the user, must be translated to ensure the end user will understand the instructions or required action or information. Such portions typically include alphanumeric strings for display to the user. Interfacing messages would be translated to ensure the end user could interact with the program. For instance, if a spreadsheet program were created in the United States and sold in Japan, the program typically would be written in English and, initially, the portions of the program used to illicit or transfer information from and to the end user (e.g., prompts and output) would also be written in English. Throughout the process of generating the software, the program and user interfaces would retain its English characteristics for ease in testing, troubleshooting, performance measurement, and program review. However, before the software product was shipped to Japan for sale, portions of the program used to interface with the end user would be translated into Japanese to ensure the user would be able to interact, i.e., understand the information being conveyed to them and would be able to input information to the software program. While the portion of the software program which interfaces with the end product user would be translated, the remainder of the program would retain its English characteristics. The English format of the balance of the program would ease later program updates, program troubleshooting (if required) and normal software maintenance.

For software programs that are sold in more than one country, one way to minimize the amount of effort necessary to ensure user interfacing portions of the software are presented to the end user in the local language of the country where the product is sold, is to collect all user interfacing words, phrases, sentences, and paragraphs, into a separate file which is called by the main software routine when interface to the end user is desired. One method of interfacing the main software routine with the local language user interface is by embedding variables in the main software routine where the definitions of the variables are held in a local language user interface table. These local language user interface tables are generally referred to as string tables. If a software product was planned on being sold in more than one country, a string table would be created in each language in which the product is intended to be used.

Additional problems are encountered by the software manufacturer when string tables are created and then user interfacing language is changed after the creation of the string tables. Since the software developer is typically unfamiliar with the foreign languages, the developer must keep track of changes in the user interface's words, phrases, sentences and paragraphs in the base language to ensure that the string tables are updated accordingly.

### SUMMARY OF THE INVENTION

The present invention is directed to a system and method for creating localization data which is used to update instruction manuals, books, and computer programs to contain alphanumeric string-data forming words, phrases, sentences, and paragraphs appropriate to the native language of a user. Localization is achieved by the creation of a spreadsheet which contains one or more words in the base language or the language in which the manual or program was written, and correlates those base language components with corresponding components of other, or foreign, languages. Additionally, the present invention ensures changes in the alphanumeric strings in one language are highlighted until the corresponding foreign language strings are updated to reflect the changes. The preferred embodiment of the present invention creates string tables which contain the words, phrases, sentences and paragraphs in a language other than the base language for incorporation into the base program when the base program is compiled or executed.

### BRIEF DESCRIPTION OF THE DRAWINGS

FIG. 1 is a diagram depicting the relationship between the localization spreadsheet and the various string tables;

FIGS. 2A and 2B are tables depicting an example of various components contained within the localization spreadsheet;

FIG. 3 is a flow diagram of a program which generates string tables;

FIG. 4 is a flow diagram of the operations which occur when the localization spreadsheet is saved;

FIG. 5 is a flow diagram which shows two different modes a user can use to interface with the localization spreadsheet; and

FIG. 6 is a flow diagram of the present invention which highlights changed areas of the localization spreadsheet.

### DETAILED DESCRIPTION

Presently, a need exists for a simplified system for and method of translating interfacing word(s) from a base language in a software program to a foreign language used by a user. Additionally, a further need exists to ensure synchronization is maintained between the associated foreign word(s), the base language interfacing word(s) and included identifiers. Words are composed of alphanumeric characters, which are defined for this application as one or more printable or displayable characters including specific symbols, characters, and graphics contained in natural languages.

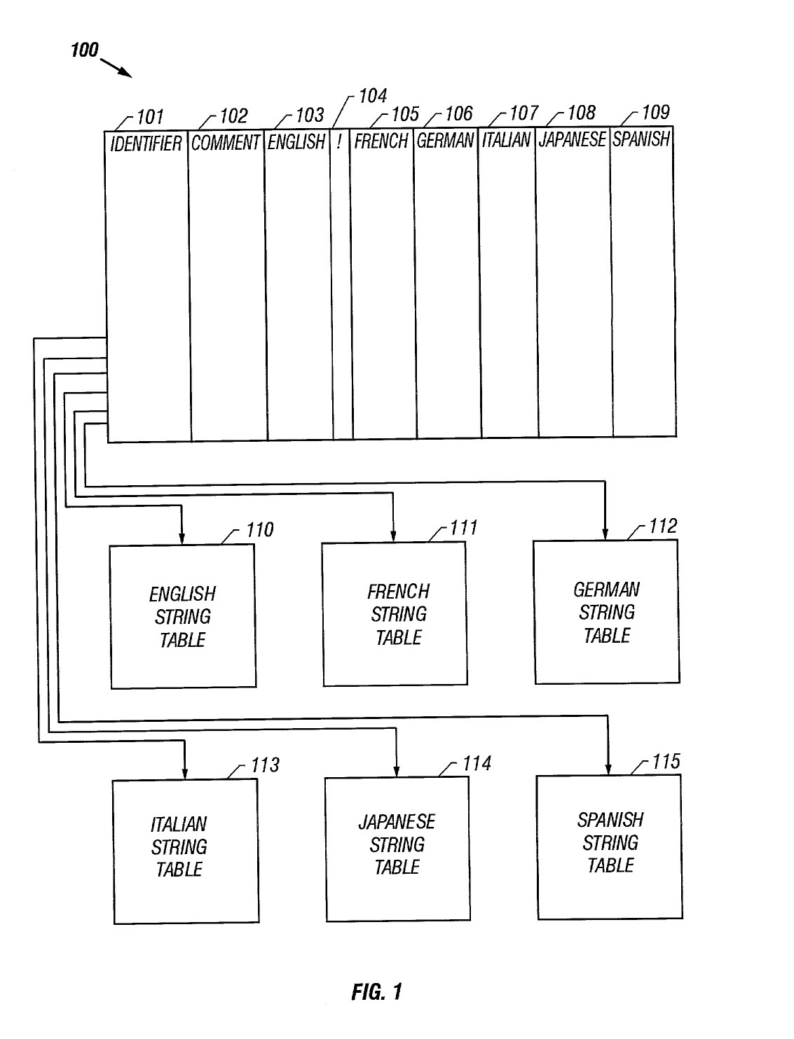

FIG. 1 is a flow diagram which shows the relationship between the localization spreadsheet and the individual language string tables. Localization spreadsheet 100 contains, for this example, nine columns including a string identifier 101, comment field 102, English language string 103, exclamation point 104, French language string 105, German language string 106, Italian language string 107, Japanese language string 108, and Spanish language string 109. Once localization spreadsheet 100 is complete, individual string tables, for each foreign language desired, are created. For example, the information contained in column 103 is used to generate English string table 110. Similarly, the information contained in column 105 is used to generate French string table 111. Similarly, string tables 112, 113, 114 and 115 are each generated in their respective languages. The column labeled with the exclamation point 104 is used to store an indication that the row corresponding to the indication has been marked for special or specific treatment. For instance, an indication in this column may be used as a “do not translate” flag. An indication in this row would ensure the alphanumerics included in English column 103 are not translated in the foreign languages. This may be used, for example, to prevent the name of a company or a product from being translated. Similarly, column 104 may be used to mark rows for other types of special treatment. Of course, several of these “marker” columns can be used, if desired. Also note that while columns are shown, one skilled in the art could use rows or could even use other organization forms to control the process.

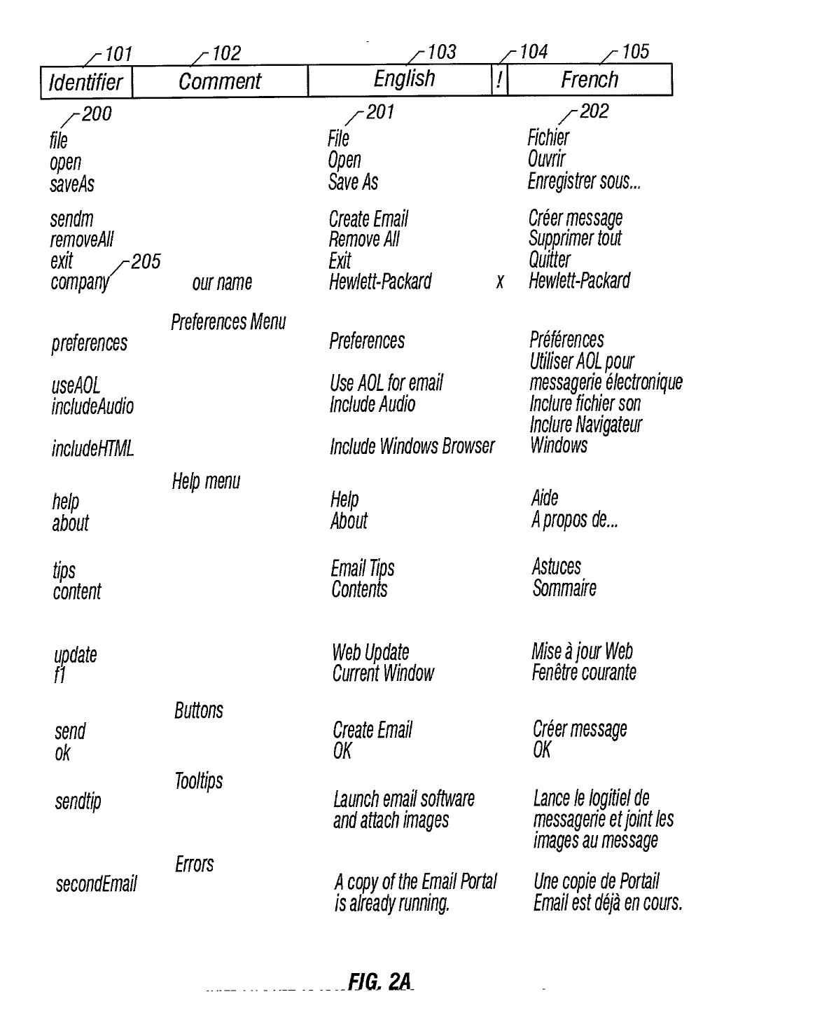

FIGS. 2A and 2B show a detailed breakout of the information contained in the columns of localization spreadsheet 100. Identifier column 101 contains descriptive terms, or even variables from the instruction manual or software program, including a description of the prompt or output which allows the programmer to determine the purpose of the specific identifier. Comment column 102 allows the programmer to include comments which will allow others to update a localization spreadsheet accordingly. English column 103 includes the English word, phrase, sentence or paragraph which is associated with the identifier in Column 101 in the same row. For example, identifier file 200 is associated with the English word file 201. Similarly, column 105 contains the French language equivalent of the corresponding English word or in this case, Fichier 202, i.e., “File.” Thus each term within each column of the localization table includes a term in the foreign language which is associated with the identifier and the English word translated into the foreign language. Row 205 includes an indication in column 104 which, in this example, indicates that the English string should be placed, unmodified, within the corresponding locations in the remaining columns.

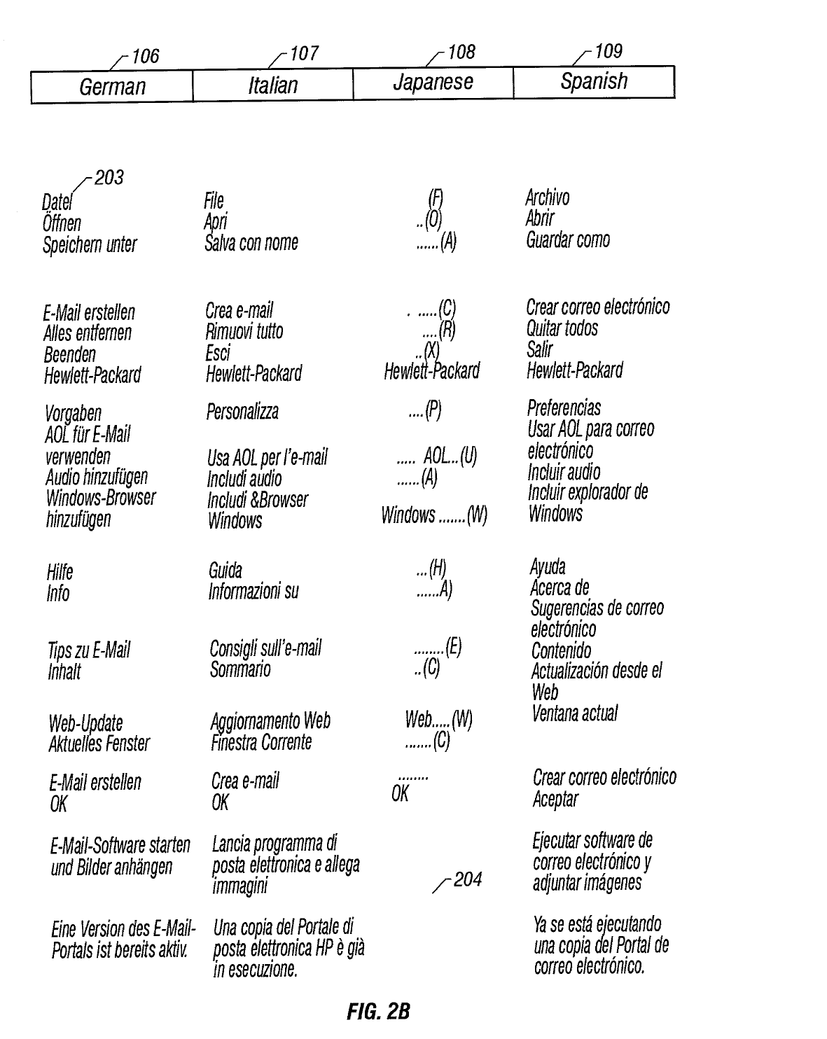

FIG. 3 is a flow diagram of process 300 which illustrates the generation of the string tables associated with the localization spreadsheet. Process 300 can work in any computing environment and can be adapted by those skilled in the art to run on any operating system and in any computer platform. Process 300 is an example of an engine which controls the system and method of the invention. In step 301 a check is performed to test whether the identifier (ID) field contains a value or is empty. If the ID field does contain a value, the program examines the next language column in step 309. The column is checked to determine if this column is the base language column, English in this example, in step 302. If the language included in the field is in the base or native language then step 303 outputs the selected string in the base language to the output string table. However, if in step 302, the column is not the base column, a check is performed at step 304 to determine whether this field contains data representing the corresponding foreign language. If the column does contain data, then the string is not empty and the foreign language string data in the field is written into the corresponding string table in step 305. Once the string data is written into the corresponding string table, in step 306, a check is performed to test to see if the foreign language string output was the last language for which a string table is required. If additional columns containing additional foreign languages exist, flow is returned to step 309, in which the next language column is selected and the process continues. One of ordinary skill in the art would understand that process 300 works across each row of the localization spreadsheet. Once the last foreign language column is addressed in step 306, the program determines in step 307 whether additional rows exist which contain data which need to be included in the associated string tables. If additional rows do exist, they are selected, as encountered, in step 310.

For example, applying process 300 to FIG. 2, in step 301 a determination would be made as to whether the ID field of the first row is empty. In order to accomplish this, the program would check the ID field 200 and determine that the word “file” is present. Next, in step 309 the program would go to the next language column and determine whether that column was the base language, or in this example English, column. As the default, the native language should always be present. In this example, column 103 would be checked and identified as the base language column. Since this word is in the English language column, step 303 is executed and the word “File” is written into a dedicated English string table. Next, test 306 is used to check to see whether English was the last language or whether other columns exist containing one or more words in corresponding foreign languages. Since additional columns exist, the program in step 309 would go to the next language column, column 105. In step 302 the program would determine that column 105 is not the base language column and continue processing at step 304. In step 304 the contents of field 202 would be examined and a determination made as to whether or not this field contains a valid string value. Cell 202 contains the string “Fichier” (i.e., French for “File”), a valid string such that program flow would continue in step 305 where “Fichier” would be written into the French string table. Flow would return to step 306 and a determination would be made that additional columns contain further additional foreign language string equivalents and program flow would return to step 309. In step 309 the next column is selected and in step 302 the column is identified as not being the base language column. In step 304 a check is made to test whether or not cell 203 is empty, in this case the program recognizing the string “Datei” (i.e., “file” in German) stored in cell 203 and step 305 would copy the string “Datei” into the German string table. This process continues left to right through the row until the information contained in the last column 109 is examined. At this point, since this is the last language for which a column exists, the test at step 306 consisting of “Was this the last language” is answered in the affirmative and flow 300 continues with step 307. In step 307 a determination is made as to whether this is the last row contained in the localization spreadsheet. From the spreadsheet depicted in FIG. 2, this question would be answered “no” and the second row of the localization spreadsheet would then be examined according to processing flow 300. This process would be continued until the last foreign language in the last row was examined and placed into a spreadsheet.

Returning to step 304, if the cell is empty, the empty test at step 304 would be passed and process flow would pass to step 308. In step 308 a determination is made as to whether the format associated with localization spreadsheet supported fallback. If fallback is supported, this means that the main software routine, using the string table, can accept an empty field without adversely affecting the operation of the main routine. An empty string in the table is replaced during program execution by a next best language string. The next best language may be predefined by the user. For example, American English may be defined to be the next best language for an empty British-English string. Similarly, France French may be predefined to be the next best language for Canadian French. During execution, empty or missing strings in a specific language may be filled with the corresponding term or string from the next best language. If the format associated with the localization spreadsheet does support fallback, the cell within the string table would be empty and step 306 would move onto the next cell in the next language. However, returning to step 308 if the format does not support fallback, a string value would need to be entered into the cell of the string table to ensure program execution would be completed. In this case, processing at step 303 writes the default, or in this example the English, entry into the associated field of the string table to ensure the operation of the main routine is not adversely impacted. Reference number 204 of FIG. 2B shows an empty string included within the table. One of ordinary skill in the art would understand that the “row” approach used by the preceding description is not required and that other variations are possible and are encompassed within this invention.

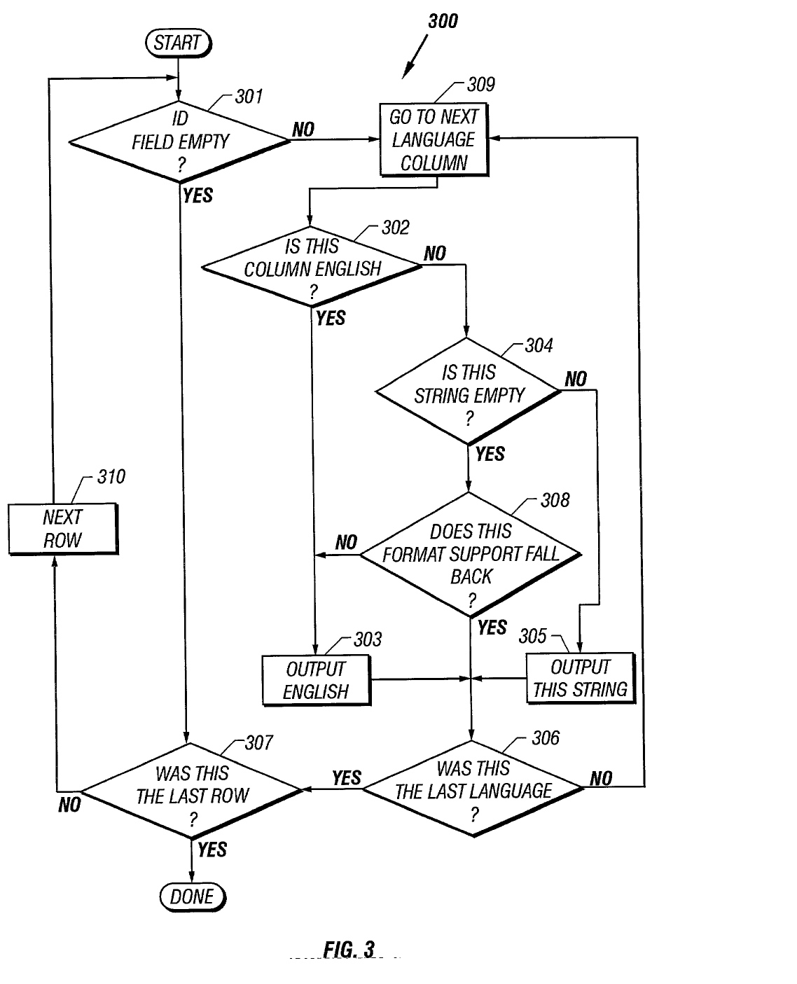

FIG. 4 is a flow diagram of the save portion of the program. In flow 400, when the user selects the save feature in edit mode in step 401 a determination is made in step 402 to identify the appropriate output format from the driver page of the spreadsheet. The driver page controls and outputs formatting information for the spreadsheet of FIGS. 2A and 2B. The driver page is a separate page which contains data specific to the programming language that the string tables will be used by. It is a separate page to help prevent accidental alterations during translation of the spreadsheet. One of ordinary skill in the art would understand that different programming languages require different string table formats. Step 402 ensures the appropriate output format will be generated. In step 403 the language tag is captured from the individual column to be associated with the specific string table. In step 404 additional language specific information is obtained from the driver page for inclusion in the appropriate string table. In step 405 the string tables may be generated. Conversely the string tables may be generated in a separate step or process. In step 406 the localization spreadsheet is saved.

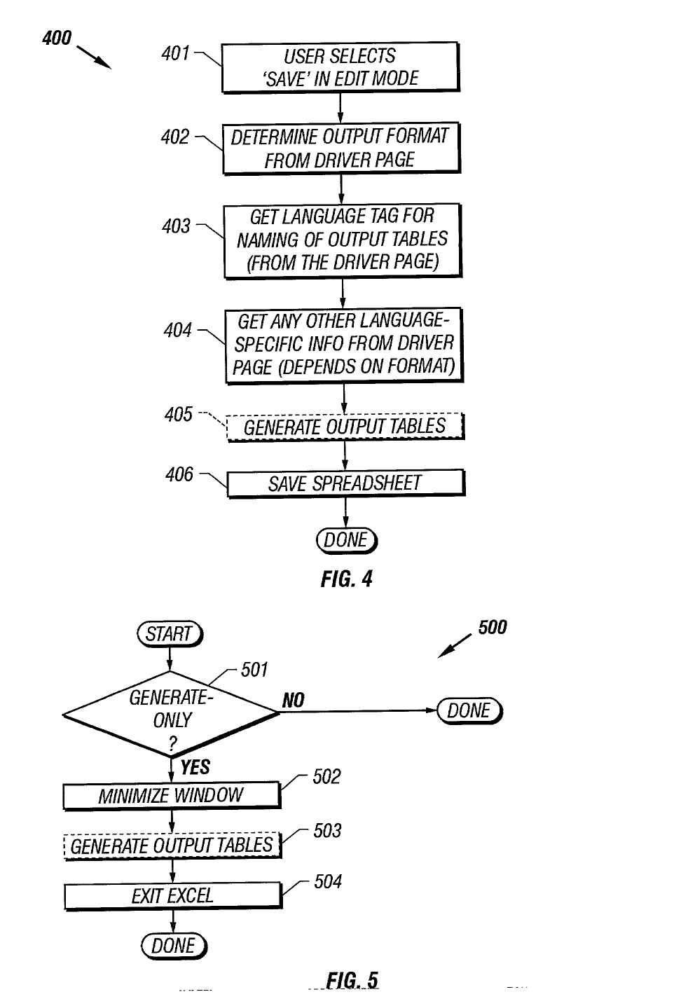

FIG. 5 is a flow diagram which shows two different modes in which a user can interface with the localization spreadsheet. Typically a user interacts with the localization spreadsheet for one of two reasons. First the user may desire to edit the information contained within the localization spreadsheet. Second, the user may desire to generate the string tables which are associated with the localization spreadsheet. Alternatively, each time the localization spreadsheet is updated, the string tables can be generated to ensure that up-to-the-minute string tables are always available. Process flow 500 of FIG. 5 begins with a check to test whether the user desires to generate the string tables or desires to edit the spreadsheet. In step 501, if the user only desires to generate the string table, processing continues at step 502 which minimizes the window and generates the output table in step 503. Once all output tables are generated, the associated spreadsheet program, such as Microsoft Excel, is exited. Alternatively, in step 501 if the user desires to edit the localization spreadsheet additional capabilities exist for the user to do that.

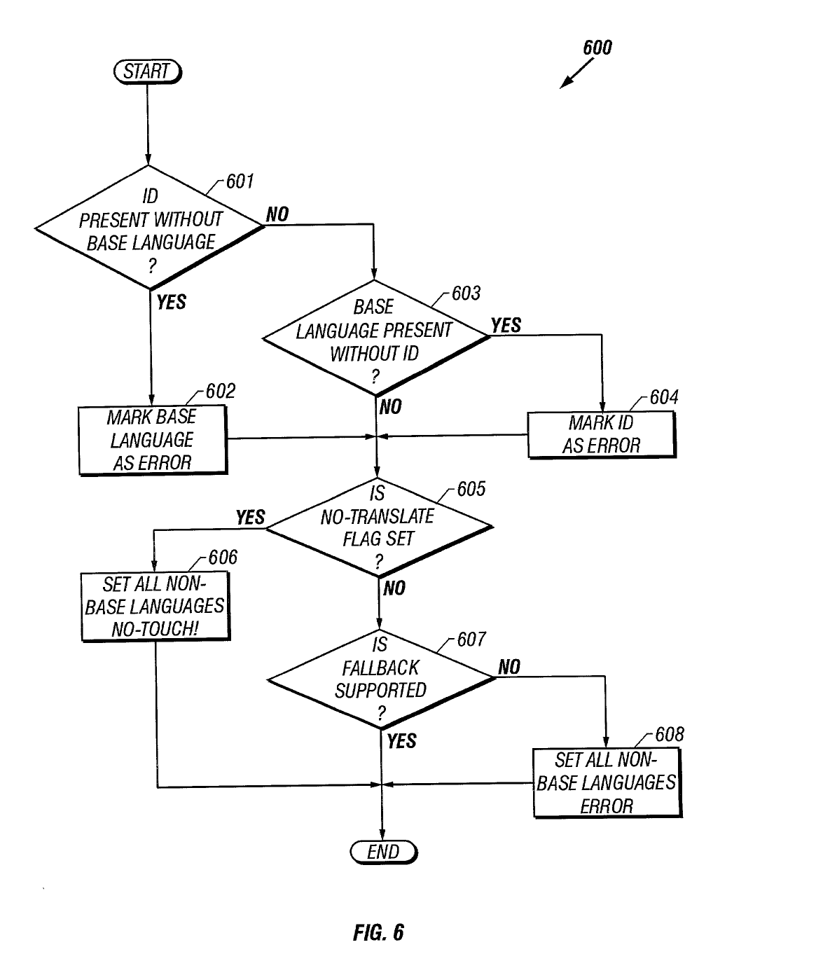

FIG. 6 is a flow diagram which shows how highlighting is incorporated to identify missing, or out-of-date information contained in the spreadsheet of FIGS. 2A and 2B. Outdated information may be introduced by changes in identifier column 101, English column 103, or column 104. Outdated information is usually identified by a user updating information within one or more cells of one or more columns. For example, referring to FIG. 2A, if “File” 201 were modified by a user, highlighting may be included to indicate that each string corresponding to “File” 201 is outdated and needs to be reviewed. By incorporating highlighting in this manner, recalculation of translations and screen updates are minimized. Processing flow 600 begins with step 601 in which a determination is made as to whether or not a base language alphanumeric string is present for each identifier present. If an identifier is present without a base language alphanumeric string, then the table position corresponding to the base language should be highlighted in step 602 indicating that the base language string requires additional information. Similarly, in step 603 a check is performed to ensure each alphanumeric string present in the base language has an associated identifier. If not, the appropriate cell in the identifier column is highlighted in step 604. Once a determination is made that each identifier corresponds to an alphanumeric string and that each alphanumeric string in the base language correspond to an identifier, in step 605 a check is performed to determine if translation is required for this row. If the determination is made in step 605 that the “no translate” flag is set, in step 606 each alphanumeric string which corresponds to the identifier, other than the base language string, is highlighted to show that no translation is needed. One example of the use of a no translate flag is the use of an indication in Column 104 of FIG. 2A.

Referring still to FIG. 6, if a determination is made in step 605 that the “no translate” flag is not set then translation is desired. A determination will be made in step 607 as to whether fallback is supported and if it is, corresponding cells in the associated tables use the alphanumeric strings in the corresponding cells of the next best language to determine the appropriate alphanumeric strings. If, however, fallback is not supported, all cells which correspond to rows in which both the identifier and the base language string are available are highlighted unless they contain an alphanumeric string. One of ordinary skill would understand highlighting includes blinking reverse video, change font color, change font size, change font type or any other action which draws attention to the specific cell.

What is claimed is:

1. A computer readable media having stored therein a documentation creation system comprising:
a localization spreadsheet including:
a first column of cells having stored therein identifiers associated with alphanumeric strings to be included in a textual document;
a second column of cells associated with respective ones of said identifiers, each cell having stored therein an alphanumeric string in a first natural language;
a third column of cells associated with respective ones of said identifiers each cell having stored therein an alphanumeric string in a second natural language; and
an engine configured to create a string table from said localization spreadsheet including said identifiers and said alphanumeric strings of one of first and second natural languages.

2. The computer readable media of claim 1 wherein said engine is further configured to generate a plurality of said string tables wherein each string table includes said alphanumeric strings from the same column of cells from said localization spreadsheet.

3. The computer readable media of claim 1 wherein said string table is used by a computer program to create screens displayed to a user of said computer program.

4. The computer readable media of claim 1 wherein said localization spreadsheet includes logic for highlighting one of said identifier in response to a change made to a corresponding alphanumeric string of one of said first and second natural languages.

5. The computer readable media of claim 1 wherein said localization spreadsheet includes logic for highlighting ones of said alphanumeric strings of one of said first and second natural language in response to a change made to a corresponding one of said identifier.

6. The computer readable media of claim 1 wherein said localization spreadsheet includes logic for highlighting, in response to a change made to one of said alphanumeric strings in said first natural language, a corresponding one of said alphanumeric strings of a second natural language.

7. The computer readable media of claim 1 wherein the localization spreadsheet further comprises:
a fourth column of cells associated with respective ones of said identifiers each cell having stored therein an alphanumeric string in a third natural language.

8. The computer readable media of claim 1 wherein said alphanumeric strings represent one of a menu, prompt and information exchange.

9. A method of creating a string table comprising the steps of:
creating a localization spreadsheet including:
storing in a first column of cells identifiers associated with alphanumeric strings to be included in a textual document;
storing in a second column of cells an alphanumeric string in a first natural language where each of said alphanumeric string is associated with respective ones of said identifiers;
storing in a third column of cells an alphanumeric string in a second natural language where each of said alphanumeric string in said second natural language is associated with respective ones of said identifiers; and
creating the string table from said localization spreadsheet including said identifiers and said alphanumeric strings of one of first and second natural languages.

10. The method of claim 9 further comprising the step of:
generating a plurality of said string tables wherein each string table includes said alphanumeric strings from the same column of cells from said localization spreadsheet.

11. The method of claim 9 further comprising the steps of:
reading said string table using a computer program;
creating screens using said alphanumeric strings contained within said string tables; and
displaying said screens to a user of said computer program.

12. The method of claim 9 further comprising the step of:
highlighting one of said identifier in response to a change made to a corresponding ones of said alphanumeric strings of one of said first and second natural languages.

13. The method of claim 9 further comprising the step of:
highlighting ones of said alphanumeric strings of one of said first and second natural language in response to a change made to a corresponding one of said identifier.

14. The method of claim 9 further comprising the step of:
highlighting, in response to a change made to one of said alphanumeric strings in said first natural language, a corresponding one of said alphanumeric strings of a second natural language.

15. The method of claim 9 further comprising the step of:
storing in a fourth column of cells an alphanumeric string in a third natural language associated with respective ones of said identifiers.

16. The method of claim 9 further comprising the step of:
representing one of a menu, prompt and information exchange by said alphanumeric string.

17. A computer readable media having stored therein:
means for associating an alphanumeric string with respective ones of said identifiers;
means for associating an alphanumeric string in a first natural language with respective ones of said identifiers;
means for associating an alphanumeric string in a second natural language with respective ones of said identifiers; and
means for creating a string table including said identifiers and said alphanumeric strings of one of first and second natural languages.

18. The computer readable media of claim 17 further comprising:
means for using said string table within a main software routine to include a foreign language in an interfacing software program.

19. The computer readable media of claim 17 further comprising:
means for reading said string table;
means for creating screens including said alphanumeric strings contained within said string tables; and
means for displaying said screens to a user.

20. The computer readable media of claim 17 further comprising:
means for highlighting ones of said alphanumeric strings of one of said first and second natural language, in response to a change made to a corresponding one of said identifier.

21. The computer readable media of claim 17 further comprising:
means for highlighting, in response to a change made to one of said alphanumeric strings in said first natural language, a corresponding one of said alphanumeric strings of a second natural language.

22. The computer readable media of claim 17 further comprising:
means for storing in a fourth column of cells an alphanumeric string in a third natural language associated with respective ones of said identifiers.

23. A method of creating a string table comprising the steps of:
creating a localization spreadsheet including:
storing in a first column of cells identifiers associated with alphanumeric strings to be included in a textual document;
storing in a second column of cells alphanumeric strings in a first natural language where each of said alphanumeric strings in said first natural language is associated with respective ones of said identifiers;
storing in a third column of cells alphanumeric strings in a second natural language where each of said alphanumeric strings in said second natural language is associated with respective ones of said identifiers;
creating a plurality of string tables from said localization spreadsheet including said identifiers and said alphanumeric strings from one of said first and second natural languages;
identifying a change in either said identifier column or in any of said language columns; and
highlighting, in response to said identifying step, entries in the other columns which are associated with identified changes in a particular column.
